(19) United States
(12) Patent Application Publication
(10) Pub. No.: US 2008/0310818 A1
(43) Pub. Date: Dec. 18, 2008

(54) Apparatus and method for generating/playing multimedia data and computer readable medium stored thereon computer executable instructions recored with time-series data structure

(75) Inventors: Jong-Hyun Kim, Gunposi (KR); Kyung-Sang Lee, Yonginsi (KR)

Correspondence Address: JONES DAY, 222 EAST 41ST ST, NEW YORK, NY, 10017, US

(73) Assignee: Core Logic, Inc.

(21) Appl. No.: 12/214,107

(22) Filed: Jun. 17, 2008

(30) Foreign Application Priority Data
Jun. 18, 2007 (KR) 10-2007-0059455

(51) Int. Cl. H04N 7/52; H04N 5/91; H04N 7/54; H04N 11/02

(52) U.S. Cl. 386/66; 386/104; 375/240.28; 375/E07.152; 375/E07.267; 375/E07.271; 375/E07.276; 386/E09.013; 386/E09.016

(57) ABSTRACT

A multimedia data generating apparatus according to the present invention comprises an encoding unit for encoding first and second data of different types; a chunk data generating unit for generating a first chunk data and a second chunk data, the first chunk data including the encoded first unit data and its identification information and size information, and the second chunk data including the encoded second unit data and its identification information and size information; and a multimedia data generating unit for generating a multimedia data, where the multimedia data contains the first chunk data and the second chunk data that are arranged and associated with each other in a temporal sequence of play.

The present invention can simply and efficiently synchronize and execute audio data and video data without operations for referring to and comparing with a time table for synchronization of each data.

### CLAIM OF PRIORITY

This application claims priority under 35 USC §119(a) to Korean Patent Application No. 10-2007-0059455, filed on Jun. 18, 2007, in the Korean Intellectual Property Office, the entire contents of which are hereby incorporated by reference.

### TECHNICAL FIELD

The present invention relates to apparatus and method for generating and playing multimedia data such as audio/video (A/V) data, and in particular, to apparatus and method for generating and playing data having such a structure that audio data or video data is arranged in time series.

### BACKGROUND

Conventionally, audio data and video data are extracted from an AV container of multimedia data containing audio data or video data by analyzing and referring to a data table with a complicated structure.

For example, MPEG-4 (Moving Picture Experts Group-4) compression method analyzes a moov box to detect location, size or time information of a bit stream, extracts necessary data using the detected information, and adjusts synchronization of audio and video data with reference to a synchronization information of each data.

That is, the conventional method decodes encoded data with reference to index about time information recorded in a table and a sub-table of each data with different properties.

The above-mentioned method may be smoothly performed in a system with a sufficient hardware infrastructure, however calculation performance may be reduced in the case that the method is performed in an MCU (MicroController Unit) with a relatively low calculation performance that is mainly used in a hardware system embedded in a small-sized equipment such as a mobile terminal, and further the method may not be easily applied on a memory.

The problem may become more remarkable in the case that a detection operation (FF/REW) of multimedia data is performed in a system with a small hardware resource.

That is, the operation should continuously detect a table information of each data for executing multimedia data of a location that a user desires, and thus requires much more resources, and in this case, the operation cannot be applied to a system with a small hardware resource and accordingly, it should use a high-cost hardware equipment.

### SUMMARY

The present invention was designed to solve the above-mentioned problems. An object of the present invention is to provide apparatus and method for generating/playing data that can easily perform synchronization of multimedia data using only data with a simple structure and perform a data detection function without reference to a table information, and a computer readable medium thereof.

These and other features, aspects, and advantages of the present invention will be more fully described in the preferred embodiments of the present invention. And, the objects and advantages of the present invention can be implemented by configurations recited in the claims singularly or in combination.

To achieve the above-mentioned objects, a multimedia data generating apparatus comprises an encoding unit for encoding first and second data of different types; a chunk data generating unit for generating a first chunk data and a second chunk data, the first chunk data including the encoded first unit data and its identification information and size information, and the second chunk data including the encoded second unit data and its identification information and size information; and a multimedia data generating unit for generating a multimedia data, where the multimedia data contains the first chunk data and the second chunk data that are arranged and associated with each other in a temporal sequence of play.

A multimedia data playing apparatus according to the present invention comprises a multimedia data input unit for receiving an input multimedia data, where the multimedia data contains first and second chunk data of different types that are arranged and associated with each other in a temporal sequence of play, each of the first and second chunk data including an encoded unit data and its identification information and size information; a judgment and output unit for determining the type of the chunk data of the multimedia data in a temporal sequence of play and outputting a chunk data according to the determined type; and a decoding unit for decoding each of the outputted chunk data into a first data or second data corresponding to the chunk data.

A multimedia data generating method according to the present invention comprises an encoding step for encoding first and second data of different types; a chunk data generating step for generating a first chunk data and a second chunk data, the first chunk data including the encoded first unit data and its identification information and size information, and the second chunk data including the encoded second unit data and its identification information and size information; and a multimedia data generating step for generating a multimedia data, where the multimedia data contains the first chunk data and the second chunk data that are arranged and associated with each other in a temporal sequence of play.

A multimedia data playing method according to the present invention comprises a multimedia data input step for receiving an input multimedia data, where the multimedia data contains first and second chunk data of different types that are arranged and associated with each other in a temporal sequence of play, each of the first and second chunk data including an encoded unit data and its identification information and size information; a judgment step for determining the type of the chunk data of the multimedia data in a temporal sequence of play and outputting a chunk data according to the determined type; and a decoding step for decoding each of the outputted chunk data into a first data or second data corresponding to the chunk data.

### BRIEF DESCRIPTION OF THE DRAWINGS

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

FIG. 1 is a block diagram illustrating a data generating apparatus according to a preferred embodiment of the present invention.

FIG. 2 is a block diagram illustrating a data generating apparatus according to another embodiment of the present invention.

FIG. 3 is a block diagram illustrating a data playing apparatus according to a preferred embodiment of the present invention.

FIG. 4 is a block diagram illustrating a data playing apparatus according to another embodiment of the present invention.

FIG. 5 is a flow chart illustrating a data generating method according to a preferred embodiment of the present invention.

FIG. 6 is a flow chart illustrating a data playing method according to a preferred embodiment of the present invention.

FIG. 7 is a view illustrating a time-series data structure according to a preferred embodiment of the present invention.

FIG. 8 is a detailed view illustrating the time-series data structure according to a preferred embodiment of the present invention.

### DETAILED DESCRIPTION

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

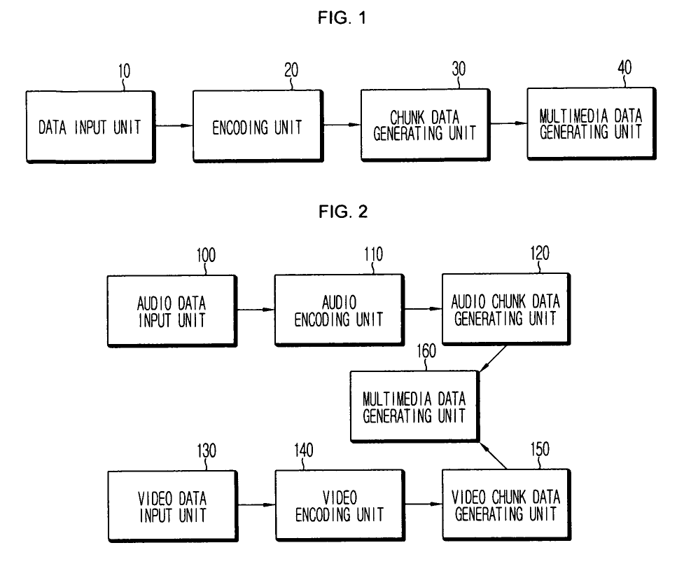

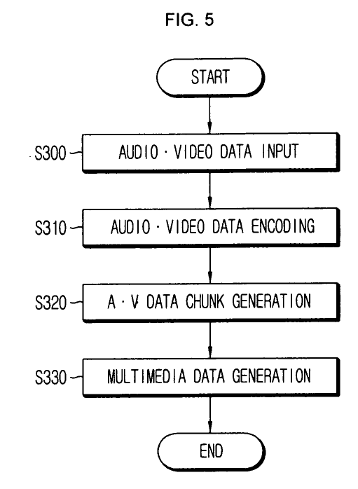

FIG. 1 is a block diagram illustrating a data generating apparatus according to a preferred embodiment of the present invention. FIG. 2 is a block diagram illustrating a data generating apparatus according to another embodiment of the present invention. FIG. 5 is a flow chart illustrating a data generating method according to a preferred embodiment of the present invention. A multimedia data generating method is described in detail through FIGS. 1, 2 and 5.

Prior to describing a configuration of the present invention in detail, a configuration shown in the accompanying drawing is just for the purpose of illustrating a configuration according to an embodiment of the present invention, and the spirit of the present invention is not limited to an embodiment shown in the drawing.

As an example, the detailed configuration of audio data or video data shown in the drawing just mentions one type of multimedia data among various multimedia data including audio character picture moving picture, text or encoded data, and it should not be construed that the present invention is limited to the above-mentioned type of data.

A multimedia data generating apparatus according to the present invention may comprise an input unit 10, an encoding unit 20, a chunk data generating unit 30 and a multimedia data generating unit 40. Each of the input unit 10, the encoding unit 20 and the chunk data generating unit 30 may perform process of components of first and second data of different types as a single integrated logic configuration, or as a separate configuration for each data according to embodiments.

Hereinafter, for efficient description, the multimedia data generating apparatus of the present invention is described as a separate configuration for each data, and first and second data of different types are described as an audio data and a video data, respectively, as an embodiment.

The multimedia data generating apparatus comprises an audio data input unit 100, an audio encoding unit 110, an audio chunk data generating unit 120, a video data input unit 130, a video encoding unit 140, a video chunk data generating unit 150, and a multimedia data generating unit 160.

The audio data input unit 100 and the video data input unit 130 perform an interface function between the apparatus of the present invention and an external system, and receive an input audio data and an input video data uncompressed before encoding, respectively (S300).

The audio data and video data input through the audio data input unit 100 and the video data input unit 130 are transmitted to the audio encoding unit 110 for encoding an audio data and the video encoding unit 140 for encoding a video data, respectively. The audio encoding unit 110 and the video encoding unit 140 encode the audio data and the video data into various types by a corresponding encoding technique, respectively (S310).

Various encoding techniques are well known to persons skilled in the art, and thus their detailed description is omitted.

The first and second data expressed in the present invention mean data of different types, and it should be understood that the first and second data are associated to be a multimedia data and include an audio data and a video data.

After the encoding step is completed, the audio chunk data generating unit 120 and the video chunk data generating unit 150 generate an audio chunk data and a video chunk data, in which the encoded unit audio data and the encoded unit video data are added with their identification information and size information, respectively (S320).

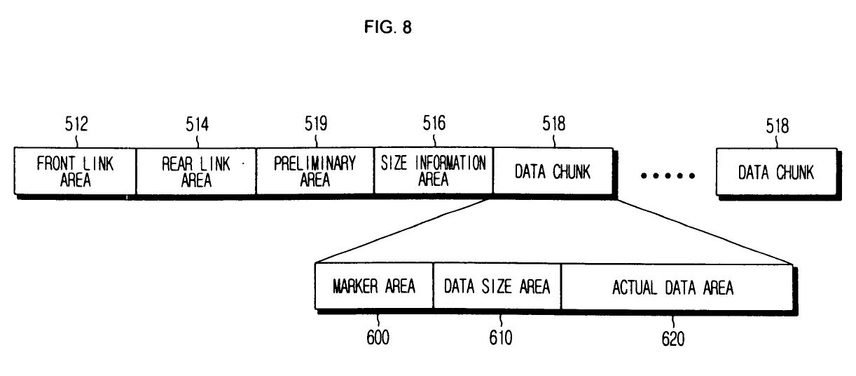

As shown in FIG. 8, each chunk data 518 includes a marker area 600 for storing data about an identification information, a data size area 610 for storing data about a size information, and an actual data area 620 for storing an encoded data.

After the chunk data 518 is generated, the multimedia data generating unit 160 associates the audio chunk data with the video chunk data such that the audio chunk data and the video chunk data are arranged in a temporal sequence of play to generate a multimedia data (S330).

Because the audio/video chunk data is arranged in a temporal sequence, when the multimedia data is decoded in order of arrangement, the audio and video chunk data is automatically kept in sync with each other without reference to a synchronization information of each data.

As mentioned above, the above-mentioned multimedia data has such a structure that the audio chunk data and the video chunk data are alternately arranged in time series, and the structure itself may be formed as a single file.

Generally, in the case that the multimedia data is a video image, the video image is encoded for a frame of each unit play time, and thus preferably the video image is configured such that an audio data corresponding to a unit play time of each frame is added to a video data.

Hereinafter, when executing the multimedia data, a step for moving to a corresponding location and performing detection is described using a data structure 500 of the present invention.

The multimedia data generating unit 160 generates at least one data block 510 arranged in time series such that data blocks 510 are divided and played by each unit of execution time. Each data block 510 includes a multimedia data, and also includes a location information data of a preceding or subsequent data block.

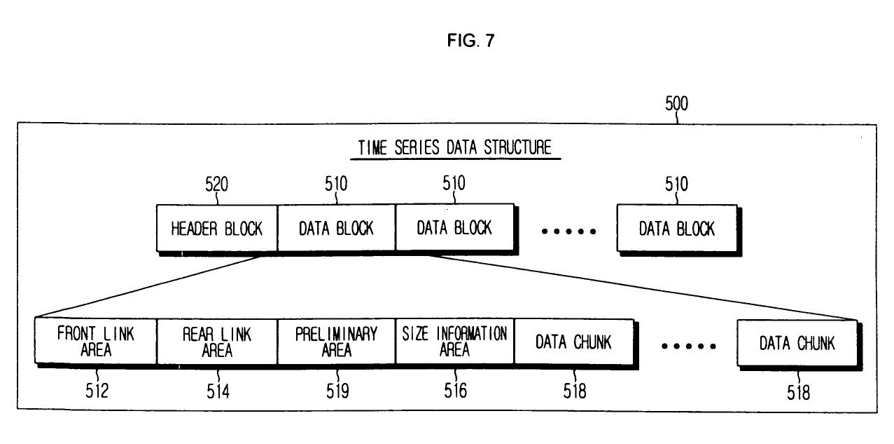

As shown in FIG. 7, the location information data of a preceding data block is recorded in a front link area 512, and the location information data of a subsequent data block is recorded in a rear link area 514.

That is, because each data block 510 includes a location information of a preceding or subsequent data block, a detection step when executing or playing the multimedia data can easily move to a data block of a desired location by tracking only the location information and execute data recorded in the moved data block.

For example, assuming that offset of a current data block is 0×300, in the case that a front link is 0×100 and a rear link is 0×200, a previous data block is located at 0×2f00 and a next data block is located at 0×3200. This movement using link incorporates an FF/REW function.

Additionally, in the case that FF/REW is 10 block movement, a single FF/REW is incorporated by 10 time detection. This process is repeated, so that a general FF/REW is performed.

And, a preceding or subsequent data block may be designated as a data block for synchronization in a continuous manner or an arbitrary data block may be designated as a data block for synchronization. The latter may be incorporated, for example, by an assigning method using the number (time) of audio frames.

A specific frame among frames may be individually decoded, however in some cases, the frame may require a decoding result resulted from previous decoding. In this case, interrelated location information of the frame is recorded in the front and rear link areas 512 and 514, and is decoded by the above-mentioned process.

When a frame decoded individually is indicated as ‘i frame’ and a frame linked to a previous decoding result is indicated as ‘p frame’, each front link area and rear link area may be designated as shown in the following Table 1. For the convenience of description, assuming each data block has the same size of 100 byte as follows.

TABLE 1

| | | FRAME | FRONT | |
|---|---|---|---|---|
| # | SIZE | INFORMATION | LINK | REAR LINK |
| DATA BLOCK 1 | 100 byte | i | 0 | 300 |
| DATA BLOCK 2 | 100 byte | p | 100 | 200 |
| DATA BLOCK 3 | 100 byte | p | 200 | 100 |
| DATA BLOCK 4 | 100 byte | i | 300 | 400 |
| DATA BLOCK 5 | 100 byte | p | 100 | 300 |
| DATA BLOCK 6 | 100 byte | p | 200 | 200 |
| DATA BLOCK 7 | 100 byte | p | 300 | 100 |
| DATA BLOCK 8 | 100 byte | i | 400 | 0 |
| DATA BLOCK 9 | 100 byte | p | 100 | 0 |

A large packet may occupy about 1 to 2 seconds, but generally 50 packets may be executed in 1 second. Thus, in the case that data is arranged in order of decoding and continuously decoded in order of association as in the above-mentioned method, because a single frame corresponds to about 1/50 seconds, mismatching in synchronization between audio data and video data is not visually or aurally recognized due to the limitations of human perceptivity. Therefore, synchronization is sufficiently achieved by the above-mentioned method.

As mentioned above, the first and second data of the present invention are of different types, and may be determined among audio data, still image data moving image data, text data and encoded data by selection according to application embodiments. The first and second data should not be interpreted literally in aspect of ordinal number, but should be interpreted as symbols representing different types.

And, in the case that some data among different types of data used in the present invention are encoded data, the data may be combined with other type of data into data with a time series data structure. Therefore, the present invention can realize expandability of a chunk data, maintain self-security by encoding, and obtain additional protection by the time series structure.

In the case that security type of encoding is individually defined, the generated encoding data may be utilized in a subsequent playing step, and a plurality of encoded data are combined with each other into a time series data structure using the method of the present invention, thereby realizing double protection.

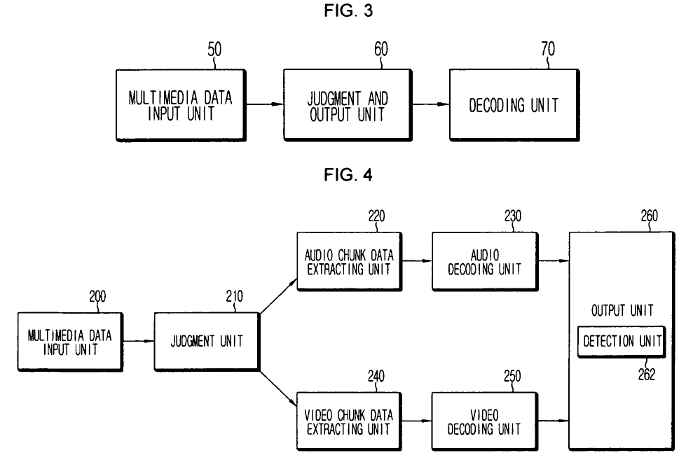

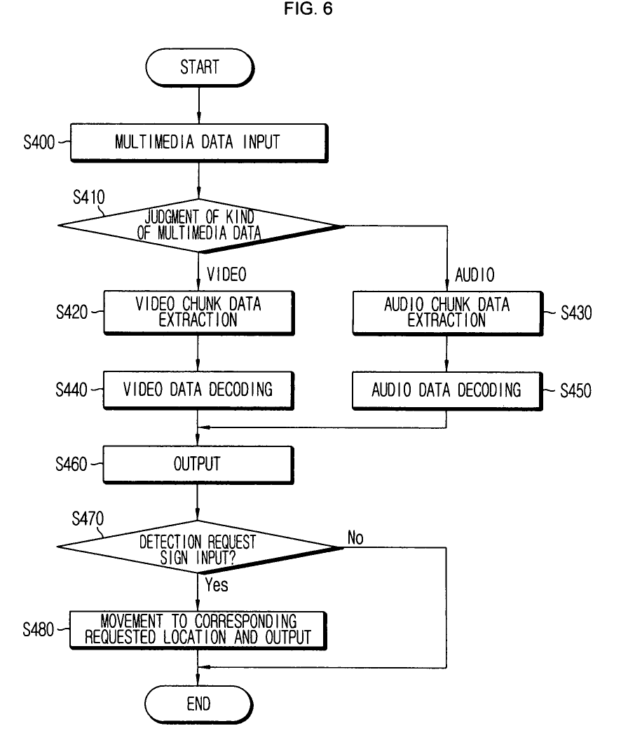

FIG. 3 is a block diagram illustrating a data playing apparatus according to a preferred embodiment of the present invention. FIG. 4 is a block diagram illustrating a data playing apparatus according to another embodiment of the present invention. FIG. 6 is a flow chart illustrating a data playing method according to a preferred embodiment of the present invention. Hereinafter, a multimedia data playing method is described through FIGS. 3, 4 and 6.

A multimedia data playing apparatus of the present invention may comprise a multimedia data input unit 50, a judgment and output unit 60, and a decoding unit 70. The judgment and output unit 60 and the decoding unit 70 may be each incorporated as an integrated configuration or as a separate configuration for each function or data type according to embodiments.

It should be understood that the generating or playing apparatus or its components according to the present invention is not divided in a physical concept, but in a logical concept. That is, because each component is divided logically to incorporate the spirit of the present invention, although each component performs its function integrally or separately, if the function performed by a logical configuration of the present invention is incorporated, it should be interpreted that it is within the scope of the present invention.

Hereinafter, for efficient description, the multimedia data playing apparatus of the present invention is described on the basis of components divided according to function and data type.

A multimedia data playing apparatus according to the present invention comprises a multimedia data input unit 200, a judgment unit 210, an audio chunk data extracting unit 220, a video chunk data extracting unit 240, an audio decoding unit 230, a video decoding unit 250, an output unit 260 and a detection unit 262.

The multimedia data input unit 200 receives an input multimedia data, where the multimedia data contains a first chunk data and a second chunk data that are arranged and associated with each other in a temporal sequence of play, the first chunk data includes an encoded first unit data and its identification information and size information, and the second chunk data includes an encoded second unit data and its identification information and size information (S400).

The multimedia data input unit 200 performs an interface function between a configuration of the present invention and an external system in the same way as the audio data input unit 100 and the video data input unit 130.

The judgment unit 210 judges the type of the chunk data of the multimedia data input through the multimedia data input unit 200 in a temporal sequence, and outputs a chunk data corresponding to the determined type.

Because the multimedia data input through the multimedia data input unit 200 is generated by association in time series, the judgment unit 210 judges the type of the chunk data in order of input.

The chunk data 518 has its identification information and size information, and if the identification information is defined, for example 0×FF00 as an MP3 data and 0×FF80 as an MPEG data, the judgment unit 210 judges the type of data based on the defined information. In the case that data is determined as an audio data, the data is transmitted to the audio chunk data extracting unit 220 (S430), and the audio decoding unit 230 decodes the extracted audio chunk data to an audio data (S450).

In the case that data is determined as a video data, the data is gone through steps S420 and S440 by the video chunk data extracting unit 240 and the video decoding unit 250.

The decoded audio/video data is outputted to an external system, and to an audio output means and a display means by control of the output unit 260 (S460).

As mentioned above, the data block 510 is configured in time series and includes a location information of a preceding or subsequent data block, and thus a data block of a desired location can be detected using the location information.

That is, the detection unit 262 of the present invention receives a detection request signal input from a user or an external system (S470), detects a play location of a data block using a location information data included in the data block, and outputs data existing at the detected location (S480).

The detection unit 262 may be included in the output unit 260 as shown in FIG. 4, or may be operated independently from an external system according to embodiments. The location information data of the data block may be inputted from the multimedia data input unit 200, the judgment unit 210, the audio chunk data extracting unit 220 and the video chunk data extracting unit 240 or the audio decoding unit 230 and the video decoding unit 250 according to embodiments.

As shown in FIG. 7, the data structure 500 used in the present invention may include at least one data block 510, and at least one data block of the above-mentioned structure may be formed as a single execution file.

A data block group including at least one data block further includes a header block 520, and the header block 520 may store various data using a profile information CRC (Cyclic Redundancy Check), for example, a data error correcting information, a time stamp for indirect information or a key for DRM (Digital Rights Management), if necessary.

And, preferably the data block 510 has a preliminary area 519 for possibility of expansion, and a size information of the data block 510 may be recorded in the size information area 516.

The multimedia data generating method according to the present invention may be incorporated as a computer readable code in a computer readable medium. The computer readable medium includes all types of storage devices for storing data readable by a computer system. For example, the computer readable medium is ROM (Read Only Memory), RAM (Random Access Memory), CD-ROM (Compact Disc Read Only Memory), a magnetic tape, a floppy disc or an optical data storage device, and may be incorporated in the form of a carrier wave (for example, transmission via the Internet). And, the computer readable medium may store and execute a code that is dispersed in computer systems connected to each other via a network and is readable by a computer through a dispersion method. Further, function program, code and code segments for implementing the method for generating multimedia data may be easily inferred by programmers in the prior art.

Only a few implementations and examples are described and other implementations, enhancements and variations can be made based on what is described and illustrated in this application.

The apparatus and method for generating and playing data with a time series structure arranged in a temporal sequence of decoding according to the present invention can achieve an effective synchronization of multimedia data using a small hardware resource when decoding.

And, the present invention can incorporate an effective detection function using information recorded in a preceding or subsequent link area of each data block without reference to a time information table, and create an effect that multimedia data is effectively decoded in an equipment required for limitation of a physical resource such as a mobile terminal.

What is claimed is:

1. A multimedia data generating apparatus, comprising:
an encoding unit for encoding a first data and a second data of different types;
a chunk data generating unit for generating a first chunk data and a second chunk data, where the first chunk data includes an encoded first unit data and its identification information and size information, and the second chunk data includes an encoded second unit data and its identification information and size information; and
a multimedia data generating unit for generating a multimedia data, where the multimedia data contains the first chunk data and the second chunk data that are arranged and associated with each other in a temporal sequence of play.

2. The multimedia data generating apparatus according to claim 1,
wherein the encoding unit includes,
a first encoding unit for encoding the first data, and
a second encoding unit for encoding the second data; and
wherein the chunk data generating unit includes,
a first chunk data generating unit for generating the first chunk data including the encoded first unit data and its identification information and size information, and
a second chunk data generating unit for generating the second chunk data including the encoded second unit data and its identification information and size information

3. The multimedia data generating apparatus according to claim 1,
wherein the multimedia data generating unit generates at least one data block that includes the multimedia data, is divided by a unit of execution time and is arranged in a temporal sequence of play, and
wherein the data block includes a location information data of a previous data block, a subsequent data block or both.

4. The multimedia data generating apparatus according to claim 1,
wherein the first data is an audio data and the second data is a video data.

5. A multimedia data playing apparatus, comprising:
a multimedia data input unit for receiving an input multimedia data, where the multimedia data contains a first and a second chunk data of different types that are arranged and associated with each other in a temporal sequence of play, where each of the first and the second chunk data includes an encoded unit data and its identification information and size information;
a judgment and output unit for determining the type of chunk data that are in the multimedia data, and outputting a chunk data according to the determined type; and
a decoding unit for decoding each of the outputted chunk data into a first data or a second data corresponding to the chunk data.

6. The multimedia data playing apparatus according to claim 5,
wherein the decoding unit includes:
a first decoding unit for decoding the outputted first chunk data into a corresponding first data; and
a second decoding unit for decoding the outputted second chunk data into a corresponding second data.

7. The multimedia data playing apparatus according to claim 5,
wherein the multimedia data is included in at least one data block that is divided by a unit of execution time and arranged in a temporal sequence of play,
wherein the data block includes a location information data of a previous data block, subsequent data block or both, and
wherein the multimedia data playing apparatus further comprises a detection unit for detecting a play location of a data block using the location information data included in the data block.

8. The multimedia data playing apparatus according to claim 5,
wherein the first data is an audio data and the second data is a video data.

9. A multimedia data generating method, comprising:
an encoding step for encoding a first data and a second data of different types;
a chunk data generating step for generating a first chunk data and a second chunk data, where the first chunk data includes an encoded first unit data and its identification information and size information, and the second chunk data includes an encoded second unit data and its identification information and size information; and
a multimedia data generating step for generating a multimedia data, where the multimedia data contains the first chunk data and the second chunk data that are arranged and associated with each other in a temporal sequence of play.

10. The multimedia data generating method according to claim 9,
wherein the multimedia data generating step generates at least one data block that includes the multimedia data, is divided by a unit of execution time and is arranged in a temporal sequence of play, and
wherein the data block includes a location information data of a previous data block, subsequent data block or both.

11. The multimedia data generating method according to claim 9,
wherein the first data is an audio data and the second data is a video data.

12. A multimedia data playing method, comprising:
a multimedia data input step for receiving an input multimedia data where the multimedia data contains a first and a second chunk data of different types that are arranged and associated with each other in a temporal sequence of play, where each of the first and the second chunk data includes an encoded unit data and its identification information and size information;
a judgment step for determining the type of chunk data that are in the multimedia data, and outputting a chunk data according to the determined type; and
a decoding step for decoding each of the outputted chunk data into a first data or a second data corresponding to the chunk data.

13. The multimedia data playing method according to claim 12,
wherein the multimedia data is included in at least one data block that is divided by a unit of execution time and arranged in a temporal sequence of play,
wherein the data block includes a location information data of a previous data block, subsequent data block or both, and
wherein the multimedia data playing method further comprises a detection step for detecting a play location of a data block using the location information data included in the data block

14. The multimedia data playing method according to claim 12,
wherein the first data is an audio data and the second data is a video data.

15. A computer readable medium stored thereon a multimedia data generating method, the multimedia data generating method comprising:
an encoding step for encoding a first data and a second data of different types;
a chunk data generating step for generating a first chunk data and a second chunk data, where the first chunk data includes an encoded first unit data and its identification information and size information, and the second chunk data includes an encoded second unit data and its identification information and size information; and
a multimedia data generating step for generating a multimedia data, where the multimedia data contains the first chunk data and the second chunk data that are arranged and associated with each other in a temporal sequence of play.

16. A computer readable medium stored thereon a multimedia data playing method, the multimedia data playing method comprising:
a multimedia data input step for receiving an input multimedia data, where the multimedia data contains a first and a second chunk data of different types that are arranged and associated with each other in a temporal sequence of play, where each of the first and the second chunk data includes an encoded unit data and its identification information and size information;
a judgment step for determining the type of chunk data that are in the multimedia data, and outputting a chunk data according to the determined type; and
a decoding step for decoding each of the outputted chunk data into a first data or a second data corresponding to the chunk data.
